(19) United States
(12) Patent Application Publication
(10) Pub. No.: US 2009/0011329 A1
(43) Pub. Date: Jan. 8, 2009

(54) SECONDARY BATTERY

(75) Inventor: Ji-Hyoung YOON, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/118,990

(22) Filed: May 12, 2008

(30) Foreign Application Priority Data
Jul. 3, 2007 (KR) 2007-66604

(51) Int. Cl. H01M 2/08

(52) U.S. Cl. 429/174

(57) ABSTRACT

A secondary battery including: an electrode assembly including a positive electrode plate, a negative electrode plate, and a separator located between the two plates; a lower collector plate located beneath the electrode assembly, and electrically connected to the positive electrode plate or the negative electrode plate; a fixing member disposed around the periphery of the lower collector plate; a can to accommodate the electrode assembly, the lower collector plate and the gasket; and a cap assembly to seal the can. The fixing member is located between and in contact with the can and the electrode assembly. The secondary battery can included an upper insulating plate disposed on the electrode assembly, located between and in contact with the electrode assembly and a beading part of the can.

### CROSS-REFERENCE TO RELATED APPLICATION

This application claims the benefit of Korean Application No. 2007-66604, filed Jul. 3, 2007, in the Korean Intellectual Property Office, the disclosure of which is incorporated herein by reference.

### BACKGROUND OF THE INVENTION

1. Field of the Invention

Aspects of the present invention relate to a secondary battery, and more particularly, to a secondary battery in which an unwanted electrical short-circuit does not occur.

2. Description of the Related Art

In recent years, compact, portable electronic devices, such as, cellular phones, notebook computers, camcorders, and so on, have been actively developed and produced. These devices generally use a battery pack during portable operation. In consideration of economical concerns, the battery pack generally uses a secondary battery that is rechargeable, such as, a nickel-cadmium (Ni—Cd) battery, a nickel-metal hydride (Ni-MH) battery, and a lithium (Li) battery.

Li secondary batteries are widely used in the portable electronic devices, because the Li secondary batteries have an operating voltage three times lager than that of the Ni—Cd or Ni-MH batteries, and an energy density per unit weight that is larger than that of the Ni—Cd or Ni-MH batteries. The Li secondary batteries may be classified as liquid-type or polymer-type, depending on whether the Li secondary battery uses a liquid electrolyte or a polymer electrolyte,. The secondary batteries may be classified as cylindrical, square, and pouch-shaped batteries, depending on the shapes thereof.

A cylindrical secondary battery typically includes: a cylindrically-wound electrode assembly; a center pin located at the center of the electrode assembly; a can to accommodate the electrode assembly, the center pin, and an electrolyte that moves Li ions within the electrode assembly; and a cap assembly to seal the can. The electrode assembly comprises: a positive electrode plate having a positive electrode collector coated with a positive electrode active material; a positive electrode tap electrically connected to one side of the positive electrode collector; a negative electrode plate having a negative electrode collector coated with a negative electrode active material; a negative electrode tap electrically connected to one side of the negative electrode collector; and a separator disposed between the two electrode plates.

The center pin is located at the center of the electrode assembly. The center pin suppresses deformation of the electrode assembly, when the electrode assembly is charged or discharged. The center pin has a longitudinal hole formed therein. The hole acts as a passage for releasing a gas created by the electrode assembly during abnormal operations, to the cap assembly.

In such a cylindrical secondary battery, when the electrode assembly is located too close to the can, the electrode assembly may be deformed, due to the gas created by the electrode assembly, resulting in damage during charging and/or discharging. Also, when the electrode assembly is received into the can, the electrode assembly may be damaged by contacting the can. This may reduce or degrade the lifetime and/or the efficiency of the cylindrical secondary battery.

Therefore, to prevent life-time and/or efficiency declines of the cylindrical secondary battery, due to damage to the electrode assembly, the diameter of the electrode assembly may be a fixed percentage of the diameter of the can, to maintain a sufficient spacing between the electrode assembly and the can.

However, when an external physical shock is applied to a cylindrical secondary battery, or a continuous vibration is applied to a cylindrical secondary battery, the electrode assembly can be moved into contact with the can, which may cause deformation or damage of the electrode assembly. In addition a short-circuit between the electrode assembly and the can may also result.

### SUMMARY OF THE INVENTION

Aspects of the present invention provide a secondary battery that prevents an external physical shock or a continuous vibration from disrupting a spacing between an electrode assembly and a can of the secondary battery. The secondary battery prevents damage to the electrode assembly, and prevents short-circuits between the electrode assembly and the can.

Exemplary embodiments of the present invention provide a secondary battery comprising an electrode assembly including: a positive electrode plate, a negative electrode plate, and a separator located between the two plates. The secondary battery includes a lower collector plate located beneath the electrode assembly, and electrically connected to the positive electrode plate or the negative electrode plate; a gasket disposed to surround the lower collector plate; a can to accommodate the electrode assembly, the lower collector plate and the gasket; and a cap assembly to seal an opening of the can. The gasket is located between, and in contact with, both the can and the electrode assembly.

Exemplary embodiments of the present invention also provide a secondary battery comprising an electrode assembly including: a positive electrode plate, a negative electrode plate, and a separator located between the two plates. The secondary battery includes an upper insulating plate located above the electrode assembly; a lower collector plate located beneath the electrode assembly, and electrically connected to the positive electrode plate or the negative electrode plate; a gasket to protect the electrode assembly and/or lower collector plate, during insertion into a can. The can accommodates the electrode assembly, the upper insulating plate, the lower collector plate and the gasket, the inside of the can being in contact with edges of the gasket. The secondary battery further comprises a cap assembly to seal the can. The upper insulating plate is located between, and in contact with, the electrode assembly and a beading part of the can.

According to aspects of the present invention, the gasket is provided between the lower collector plate, the lower insulating plate, and the can. The gasket contacts the inside of the can, so that the spacing between the electrode assembly and the can is maintained, even if an external physical shock or a continuous vibration is applied to the secondary battery. The gasket prevents the electrode assembly from being damaged or misaligned, and prevents short-circuits between the electrode assembly and the can.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a secondary battery, according to an exemplary embodiment of the present invention;

FIGS. 2A to 2D are cross-sectional views illustrating the secondary battery of FIG. 1; and

FIGS. 3A to 3C are cross-sectional views illustrating a secondary battery, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below in order to explain the present invention, by referring to the figures. When elements are referred to as being “connected” to other elements, the elements can be “directly connected” to one another, or can be “electrically connected” to one another with other elements interposed therebetween. Additionally, when a first element is said to be “disposed” on a second element, the first element can directly contact the second element, or one or more other elements can be located therebetween.

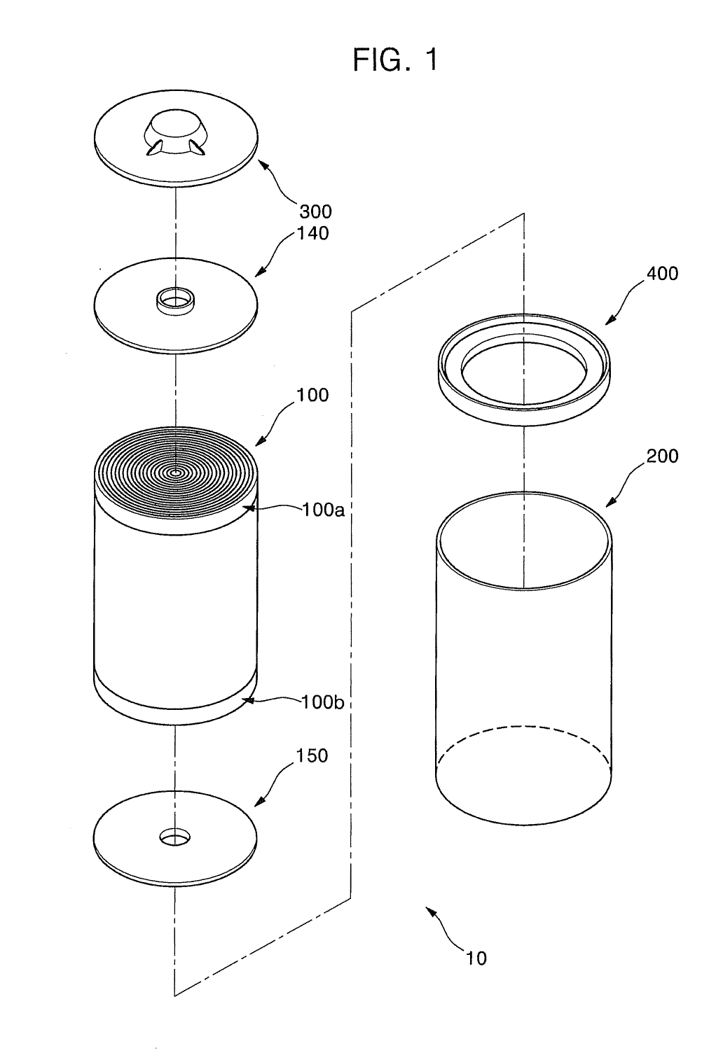

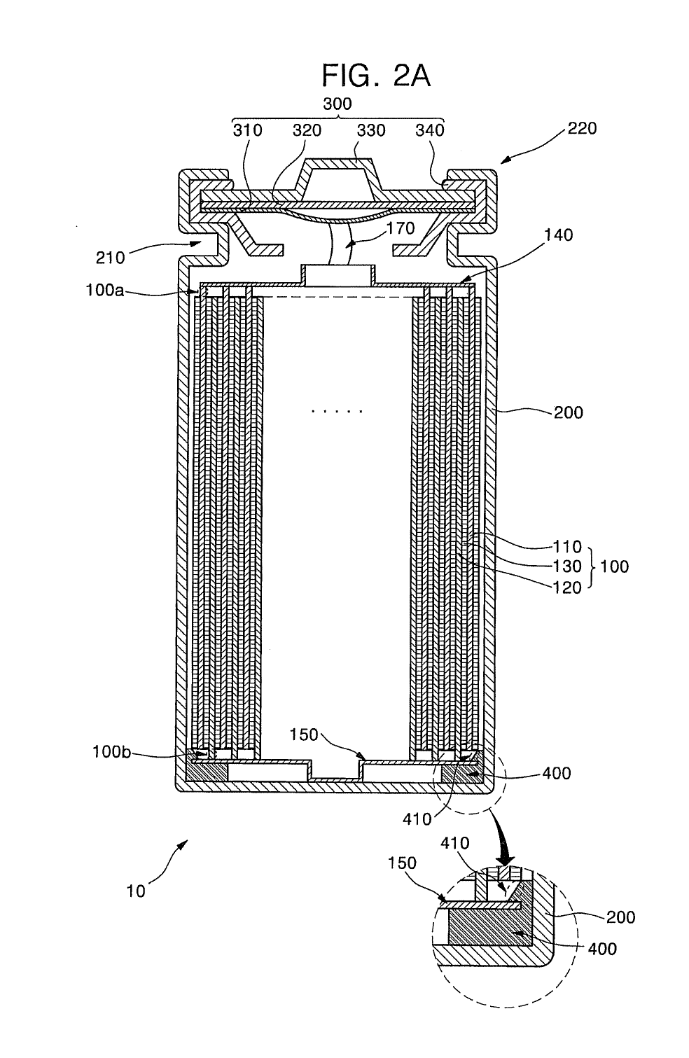

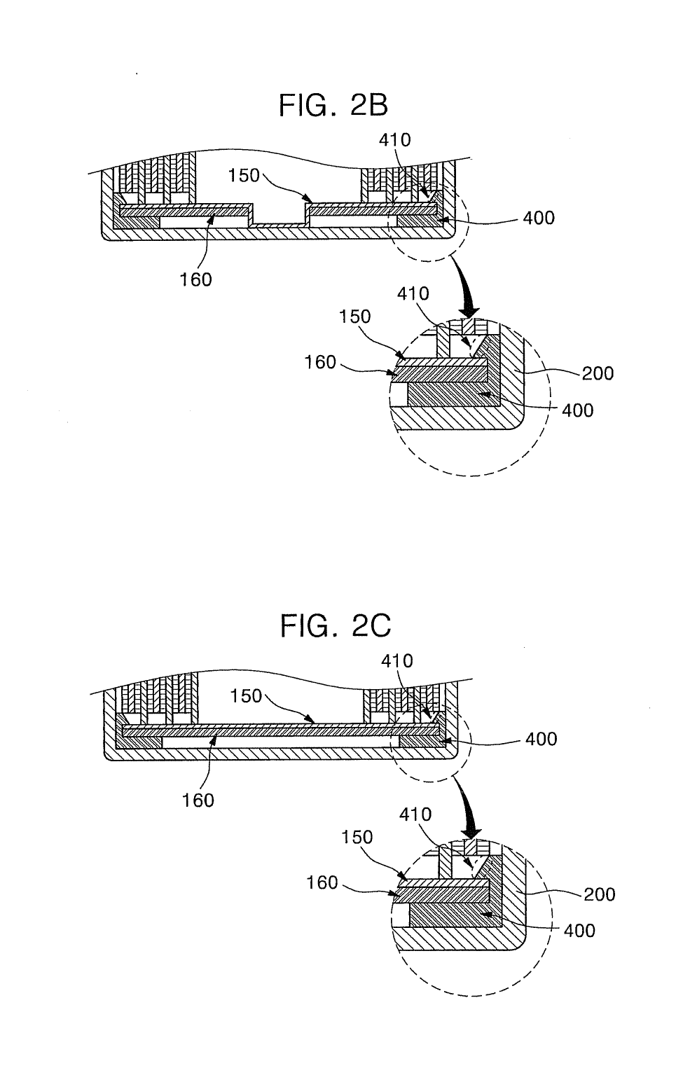

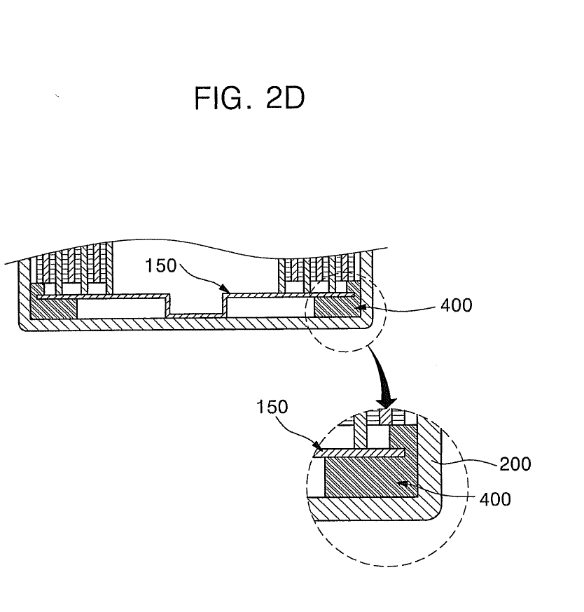

FIG. 1 is a perspective view illustrating a secondary battery 10, according to a first exemplary embodiment of the present invention, and FIGS. 2A to 2D are cross-sectional views illustrating the secondary battery 10. Referring to FIGS. 1 and 2A, the secondary battery 10 comprises a cylindrically wound, electrode assembly 100; a lower collector plate 150 located beneath the electrode assembly 100, and electrically connected to the electrode assembly 100; a fixing member 400 disposed around the lower collector plate 150; an upper collector plate 140 located on the electrode assembly 100, and electrically connected to the electrode assembly 100; a can 200 to accommodate the electrode assembly 100, the upper collector plate 140, the lower collector plate 150 and the fixing member 400; a cap assembly 300 to seal the can 200; and a lead tap 170 to electrically connect the upper collector plate 140 to the cap assembly 300. Although the secondary battery 10 depicts that the upper collector plate 140 is located on the electrode assembly 100, and the upper collector plate 140 is electrically connected with a safety vent 310, via the lead tap 170, the electrode assembly 100 may be electrically connected to the safety vent 310, via the lead tap 170, without connecting to the upper collector plate 140.

The electrode assembly 100 comprises a positive electrode plate 110 having a positive electrode collector (not shown) partially coated with a positive electrode active material (not shown). The electrode assembly 100 comprises a negative electrode plate 120 having a negative electrode collector (not shown) partially coated with a negative electrode active material (not shown), and a separator 130 located between the positive electrode plate 110 and the negative electrode plate 120. The electrode assembly 100 is electrically connected to the upper collector plate 140, or the lower collector plate 150, via uncoated regions 100a or 100b, of the positive electrode collector or the negative electrode collector. The uncoated regions 100a and 100b are not coated with the positive or negative electrode active material.

The positive electrode active material may include an Li transition metal oxide or an Li chalcogenide compound, such as, LiCoO₂, LiNiO₂, LiMnO₂, LiMn₂O₄, or LiNi_{1-x-y}CoₓM_{y}O₂ (where, 0≦x≦1, 0≦y≦1, 0≦x+y≦1, and M denotes a metal such as Al, Sr, Mg, and La). The negative electrode active material may include a carbon material, such as, a crystalline carbon, an amorphous carbon, a carbon composite, and a carbon fiber; an Li metal; or an Li alloy.

The positive electrode collector or the negative electrode collector may be formed of a material selected from the group consisting of: stainless steel, nickel, copper, aluminum, and an alloy thereof. The positive electrode collector can be formed of aluminum or an aluminum alloy and the negative electrode collector can be formed of copper or a copper alloy, in order to maximize efficiency.

The separator 130 is located between the positive electrode plate 110 and the negative electrode plate 120, to prevent electrical short-circuits between the two plates. The separator 130 allows for movement of Li ions therethrough. The separator 130 may be formed of a polyolefine-based polymer film, such as, polyethylene (PE), polypropylene (PP), or a combination thereof.

The upper collector plate 140 is electrically connected to the uncoated region 100a of the positive electrode plate 110. The lower collector plate 150 is electrically connected to a uncoated region 100b of the negative electrode plate 120. The upper collector plate 140 and the lower collector plate 150 have different polarities. Although the secondary battery 10 is described as having the upper collector plate 140 electrically connected to the positive electrode plate 110 and the lower collector plate 150 electrically connected to the negative electrode plate 120; the upper collector plate 140 may be electrically connected to the negative electrode plate 120 and the lower collector plate 150 may be electrically connected to the positive electrode plate 110. Alternatively, the upper collector plate 140 and the lower collector plate 150 may be electrically connected to the uncoated regions 100a and 100b of the positive electrode plate 110 and the negative electrode plate 120, respectively, via electrode taps (not shown).

The cap assembly 300 comprises a cap-up 330 coupled with a top opening of the can 200, to seal the can 200. The cap-up can be electrically connected with an external terminal. The cap assembly 300 comprises a safety vent 310 electrically connected with the upper collector plate 140. The safety vent 310 can be deformed or damaged when an internal pressure of the secondary battery 10 exceeds a predetermined level, due to a gas created by the electrode assembly 100, so that the gas can escape. The cap assembly 300 comprises a current interrupt device (CID) 320 located on the safety vent 310, which can be damaged or blocked by the safety vent 310, when the safety vent 310 is deformed or damaged, so that an electrical connection, between the electrode assembly 100 and the external terminal, is blocked. The cap assembly 300 comprises a gasket 340 to insulate the cap assembly 300 from the can 200. The cap assembly 300 may further comprise a positive temperature coefficient (PTC) (not shown) located between the CID 320 and the cap-up 330, to prevent an over-current from flowing between the electrode assembly 100 and the external terminal.

The can 200 is formed in a cylindrical shape having a predetermined radius, and has the top opening and a bottom circular face. The can 200 accommodates the electrode assembly 100, the upper collector plate 140, the lower collector plate 150, and an electrolyte (not shown). The electrolyte transmits Li ions created by an electrochemical reaction occurring on the positive electrode plate 110 and the negative electrode plate 120 upon charging and discharging. The electrolyte may be a non-aqueous organic electrolyte, which is a mixture of an Li salt and a high-purity organic solvent. The electrolyte can be a polymer electrolyte including an Li salt.

The can 200 is generally formed of a lightweight, flexible, and conductive metal material, such as, aluminum, an aluminum alloy, or stainless steel. The can 200 acts as a positive terminal or a negative terminal, when the lower collector plate 150 is electrically connected with the can 200.

The can 200 comprises a beading part 210 formed by indenting an outer periphery of the can 200. The beading part 210 is generally disposed adjacent to a lower portion of the cap assembly 300. The beading part 210 prevents the cap assembly 300 from being separated from the can 200, after the can 200 is sealed by the cap assembly 300. The can 200 further comprises a crimping part 220 disposed on the top of the can 200. An upper portion of the crimping part 220 is bent over the cap assembly 300. The beading part 210 and the crimping part 220 improve the coupling between the cap assembly 300 and the can 200. The beading part 210 and the crimping part 220 prevent the electrolyte from leaking out of the can 200, and firmly seal the can 200 when an internal pressure increases.

The fixing member 400 encloses the periphery of the lower collector plate 150. The fixing member is disposed in contact with the electrode assembly 100 and the can 200. The fixing member 400 prevents the lower collector plate 150 and the electrode assembly 100 from contacting a sidewall of the can 200, due to an external physical shock or a continuous vibration. Here, the fixing member 400 may have an external diameter equal to an inner diameter of the can 200. A fastening region 410 is located at an edge of the fixing member 400 and protrudes toward the electrode assembly 100. The fastening region 410 has a beveled edge to interlock the fixing member 400 and the lower collector plate 150.

The fixing member 400 may contact the bottom face of the can 200, in order to more efficiently prevent the movement of the lower collector plate 150. The fixing member 400 has a thickness equal to a sum of a length of the lower uncoated region 100b of the electrode assembly 100, and a thickness of the lower collector plate 150. The fixing member 400 prevents the lower uncoated region 100b of the electrode assembly 100 from being brought into contact with the can 200, or being brought into contact with the bottom face of the can 200. The fixing member 400 can have a thickness of 0.5 to 10 mm, in consideration of a typical length of the lower uncoated region 100b of the electrode assembly 100, and a typical thickness of the lower collector plate 150.

A lower insulating plate 160, as shown in FIG. 2B, may be provided between the bottom face of the can 200 and the lower collector plate 150, to prevent a short-circuit between the lower collector plate 150 and the bottom face of the can 200. In this case, the fixing member 400 is formed to enclose the periphery of the lower collector plate 150 and the lower insulating plate 160, so that the lower collector plate 150 and the lower insulating plate 160 do not move laterally, due to an external physical shock or a continuous vibration.

The lower insulating plate 160 may be formed of an insulating material, such as, a polyolefine-based material, for example, polyethlene (PE), polypropylene (PP), or a synthetic resin including polyvinyl chloride (PVC) and polyvinylidene fluoride (PVDF). To prevent a short-circuit between the can 200 and the electrode assembly 100 or the lower collector plate 150, the fixing member 400 may be formed of the same material as the lower insulating plate 160, or can be integrally formed with the lower insulating plate 160.

Alternatively, the fixing member 400 may be formed of a conductive material, such as, aluminum, an aluminum alloy, or stainless steel. Where the fixing member 400 is formed of a conductive material, the lower collector plate 150 is formed in a plate-shape, as shown in FIG. 2C, so that, even when the lower collector plate 150 and the bottom face of the can 200 are not in direct contact with each other, via the lower insulating plate 160, the bottom face of the can 200 and the lower collector plate 150 are electrically connected to each other, via the fixing member 400. This configuration also makes it possible to manufacture the lower collector plate 150 more easily.

The fixing member 400 may be electrically connected with the lower collector plate 150, via welding. To facilitate the welding of the fixing member 400 and the lower collector plate 150, the fixing member 400 may be formed of the same material as the lower collector plate 150. Since the fixing member 400 may be welded to the can 200 to establish an electrical connection, the fixing member 400 may be formed of the same material as the can 200. A welded area generally has a predetermined roughness. The fixing member 400 and the lower collector plate 150 can be welded in an area where they are not in contact with the bottom face of the can 200. To this end, the fixing member 400 and the lower collector plate 150 are welded at coupling areas thereof, with the coupling areas being parallel with each other, as shown in FIG. 2D.

In the secondary battery 10, the fixing member 400 is in contact with the inside of the can 200, and surrounds the edge of the lower collector plate 150, or the edges of the lower collector plate 150 and the lower insulating plate 160. The fixing member 400 fills the space between the lower collector plate 150 or the lower insulating plate 160, and the sidewalls of the can 200. This configuration prevents the lower collector plate 150 and/or the lower insulating plate 160 from moving laterally, due to external physical shock or a continuous vibration.

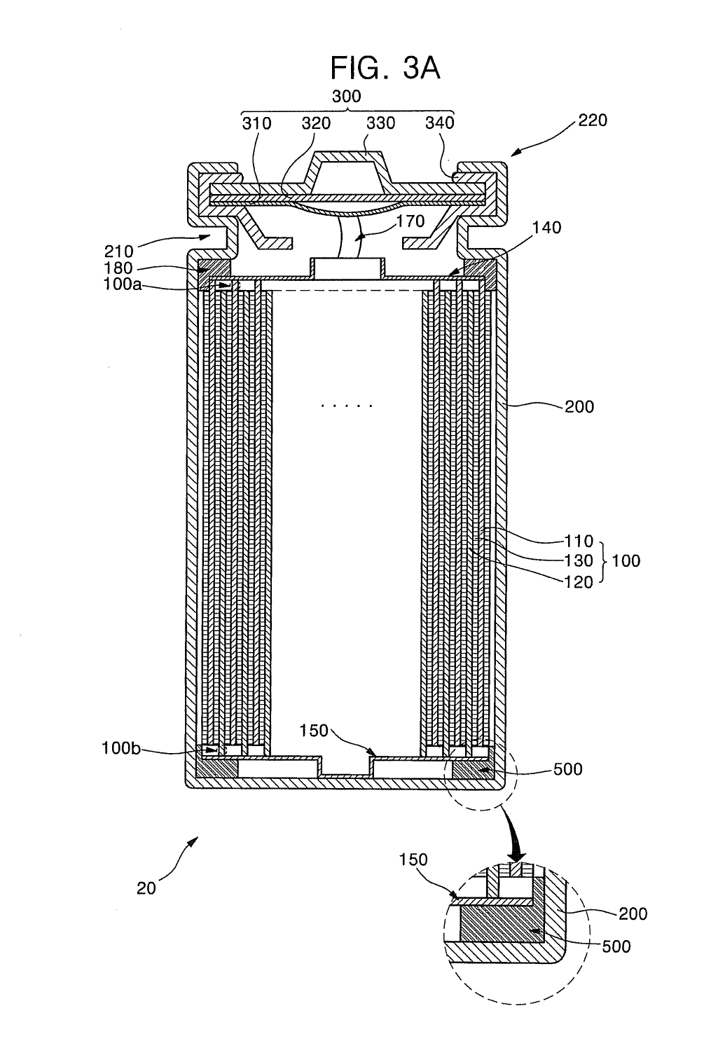

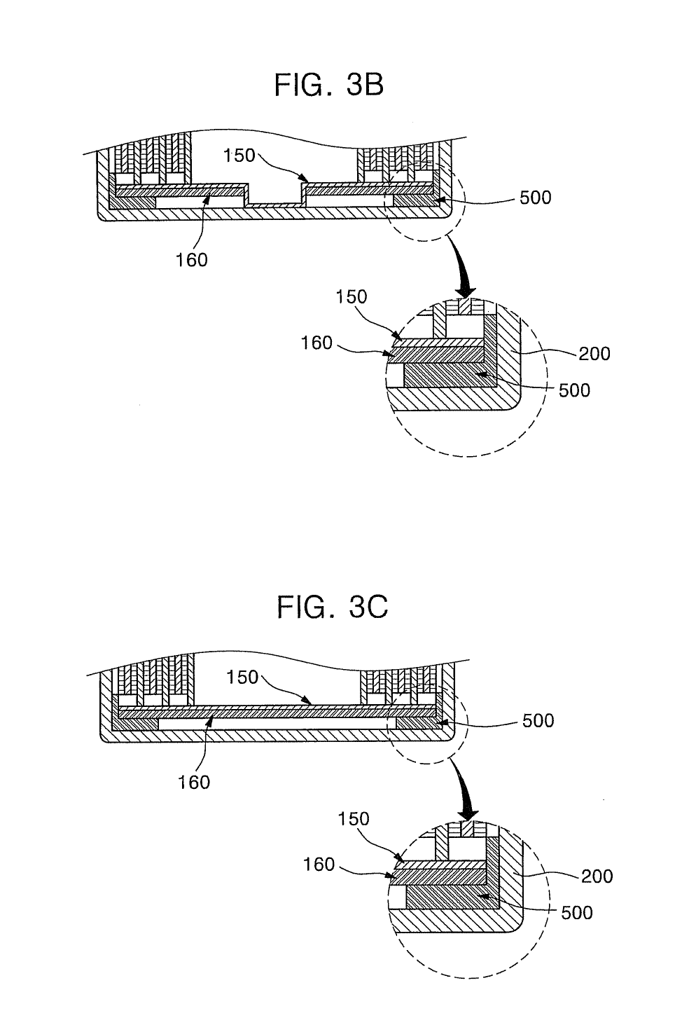

FIGS. 3A to 3C are cross-sectional views illustrating a secondary battery 20, according to an exemplary embodiment of the present invention. Referring to FIG. 3A, the secondary battery 20 comprises: a cylindrically-wound electrode assembly 100; a lower collector plate 150 located beneath the electrode assembly 100, and electrically connected to the electrode assembly 100; a fixing member 500 to surround edges of the lower collector plate 150; an upper collector plate 140 located on the electrode assembly 100, and electrically connected to the electrode assembly 100; an upper insulating plate 180 to cover the upper collector plate 140; a can 200 to accommodate the electrode assembly 100, the upper collector plate 140, the lower collector plate 150, the upper insulating plate 180, and the fixing member 500; a cap assembly 300 to seal the can 200; and a lead tap 170 to electrically connect the upper collector plate 140 to the cap assembly 300. Since the electrode assembly 100, the lower collector plate 150, the upper collector plate 140, the can 200, and the cap assembly 300, are the same as those in the secondary battery 20, a detailed description thereof is omitted.

The fixing member 500 has an edge protruding toward the cap assembly 300, to protect the lower collector plate 150 when it is inserted into the can 200. The fixing member 500 does not have the fastening region 410 to couple with the lower collector plate 150. Accordingly, the fixing member 500 can be more easily manufactured than the fixing member 400.

The fixing member 500 may be in contact with the bottom face of the can 200, in order to more prevent the movement of the lower collector plate 150. The fixing member 500 can have a thickness equal to a sum of the length of the lower uncoated region 100b and a thickness of the lower collector plate 150, to prevent the lower uncoated region 100b from being brought into contact with the side walls of the can 200 and/or the bottom face of the can 200. The fixing member 500 can have a thickness of from 0.5 to 10 mm, in consideration of a typical length of the lower uncoated region 100b and a typical thickness of the lower collector plate 150.

A lower insulating plate 160 as shown in FIG. 3B, may be provided between the bottom face of the can 200 and the lower collector plate 150, to prevent a short-circuit between the lower collector plate 150 and the bottom face of the can 200. In this case, the fixing member 500 is formed to enclose the periphery of the lower collector plate 150 and the lower insulating plate 160, so that the lower collector plate 150 and the lower insulating plate 160 do not move laterally, due to external physical shock or a continuous vibration.

The lower insulating plate 160 may be formed of an insulating material, such as a polyolefine-based material, for example, polyethlene (PE), polypropylene (PP), or a synthetic resin including polyvinyl chloride (PVC) and polyvinylidene fluoride (PVDF). To prevent a short-circuit between the can 200 and the electrode assembly 100 or the lower collector plate 150, the fixing member 500 may be formed of the same material as the lower insulating plate 160, or can be integrally formed with the lower insulating plate 160.

Alternatively, the fixing member 500 may be formed of a conductive material, such as, aluminum, an aluminum alloy, or stainless steel. When the fixing member 500 is formed of a conductive material, the lower collector plate 150 is formed in a plate-shape, as shown in FIG. 3C, so that, even when the lower collector plate 150 and the bottom face of the can 200 are separated from each other by the lower insulating plate 160, the bottom face or a sidewall of the can 200 and the lower collector plate 150 are electrically connected to each other, via the fixing member 500. This configuration also makes it possible to manufacture the lower collector plate 150 more easily.

The upper insulating plate 180 is located between the beading part 210 of the can 200 and the upper collector plate 140, and is in direct contact with the upper collector plate 140 and the beading part 210 of the can 200. Pressure is applied to the upper collector plate 140, toward the lower collector plate 150, by the beading part 210 of the can 200.

While the second exemplary embodiment of the present invention describes that the upper collector plate 140 is located on the electrode assembly 100, and the upper collector plate 140 is electrically connected to the safety vent 310, via the lead tap 170; the positive electrode plate 110 or the negative electrode plate 120 can be electrically connected to the safety vent 310, via the lead tap 170, without the upper collector plate 140. The upper insulating plate 180 can be located between the electrode assembly 100 and the beading part 210 of the can 200 and can be in contact with a upper portion of the electrode assembly 100 and a lower portion of the beading part 210 of the can 200.

In the secondary battery 20 the upper insulating plate is located between the electrode assembly, or between the upper collector plate located on the electrode assembly and the beading part of the can, and in contact with the electrode assembly or the upper portion of the upper collector plate and the lower portion of the beading part of the can, so that the lower collector plate, beneath the electrode assembly, is pressed by the beading part of the can. Thus, the lower collector plate is prevented from being separated from the fixing member, toward the electrode assembly, and the lower collector plate is prevented by the fixing member, without a separate fastening region, from moving laterally.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising:
a can having an open top end and a closed bottom end;
an electrode assembly disposed in the can, comprising a positive electrode plate, a negative electrode plate, and a separator disposed between the positive and negative electrode plates;
a lower collector plate disposed adjacent to the bottom end of the can, and electrically connected to the electrode assembly;
a fixing member disposed in the bottom end of the can around the periphery of the lower collector plate, to secure the lower collector plate in the bottom end of the can; and
a cap assembly to seal the top end of the can.

2. The secondary battery according to claim 1, wherein an outer edge of the fixing member continuously contacts a side wall of the can.

3. The secondary battery according to claim 1, wherein the fixing member is electrically insulating.

4. The secondary battery according to claim 3, wherein the fixing member comprises a polyolefine-based material or a synthetic resin.

5. The secondary battery according to claim 1, wherein the fixing member comprises polyethlene (PE) or polypropylene (PP).

6. The secondary battery according to claim 1, wherein the fixing member comprises polyvinyl chloride (PVC) or polyvinylidene fluoride (PVDF).

7. The secondary battery according to claim 1, further comprising a lower insulating plate disposed at the bottom end of the can, to insulate a bottom face of the can from the lower collector plate.

8. The secondary battery according to claim 7, wherein the fixing member contacts a sidewall of the can, edges of the lower collector plate, and the lower insulating plate.

9. The secondary battery according to claim 8, wherein the fixing member is formed of a conductive material.

10. The secondary battery according to claim 9, wherein the fixing member and the lower insulating plate are formed of the same material.

11. The secondary battery according to claim 1, wherein the fixing member comprises a beveled edge to interlock with the lower collector plate.

12. The secondary battery according to claim 1, wherein the fixing member is formed of a conductive material.

13. The secondary battery according to claim 12, wherein the fixing member is formed of any one selected from the group consisting of aluminum, an aluminum alloy, and stainless steel.

14. The secondary battery according to claim 12, wherein the fixing member and the can are formed of the same material.

15. The secondary battery according to claim 1, wherein the fixing member has a thickness equal to a sum of a length of an uncoated region of the electrode assembly and a thickness of the lower collector plate.

16. The secondary battery according to claim 15, wherein the thickness of the fixing member is from 0.5 to 10 mm.

17. A secondary battery comprising:
a can having an open top end having a beading part, and a closed bottom end;
an electrode assembly disposed in the can, comprising a positive electrode plate, a negative electrode plate, and a separator disposed between the positive and negative electrode plates;
an upper insulating plate disposed at the top end of the can, in contact with the electrode assembly and the beading part of the can;
a lower collector plate disposed in the bottom end of the can beneath the electrode assembly, and electrically connected to the electrode assembly;
a fixing member disposed in the bottom end of the can, to secure the electrode plate in the bottom end of the can; and
a cap assembly to seal the top end of the can.

18. The secondary battery according to claim 17, further comprising an upper collector plate disposed in the upper end of the can, and electrically connected to the electrode assembly,
wherein the upper insulating plate is located between and in contact with the upper collector plate and a beading part of the can.

19. The secondary battery according to claim 17, wherein an outer edge of the fixing member continuously contacts a side wall of the can.

20. The secondary battery according to claim 17, wherein the fixing member is formed of an insulating material.

21. The secondary battery according to claim 17, wherein the fixing member comprises a polyolefine-based material or a synthetic resin.

22. The secondary battery according to claim 17, further comprising a lower insulating plate disposed at the bottom end of the can, to insulate the lower collector plate from the can.

23. The secondary battery according to claim 22, wherein the fixing member is formed of a conductive material.

24. The secondary battery according to claim 17, wherein the fixing member comprises a beveled edge to interlock with the lower collector plate.

25. The secondary battery according to claim 17, wherein the fixing member has a thickness equal to a sum of a length of a uncoated region of the electrode assembly and a thickness of the lower collector plate.

26. The secondary battery according to claim 17, wherein the thickness of the fixing member is from 0.5 to 10 mm.
